(19) United States
(12) Patent Application Publication
(10) Pub. No.: US 2023/0138020 A1
(43) Pub. Date: May 4, 2023

(54) EVOLUTIONARY ALGORITHM ANALYTICS

(71) Applicant: International Business Machines Corporation, Armonk, NY (US)

(72) Inventor: Lindsey Peyton Sample, Boston, MA (US)

(21) Appl. No.: 17/453,185

(22) Filed: Nov. 2, 2021

(51) Int. Cl. G06N 3/08; G06N 3/04

(52) U.S. Cl. CPC G06N 3/086; G06N 3/0454

(57) ABSTRACT

One or more computer processors select a set of artificial neural networks (ANN(s)). The one or more computer processors determine a selection criteria from a set of input data, wherein the selection criteria is utilized as a reward function. The one or more computer processors rank each ANN in the set of ANNs based on respective fitness values calculated from respective returned output data responsive to the set of input data, wherein each ANN in the set of ANNs is ranked in a context of maximizing the determined selection criteria. The one or more computer processors iteratively create additional sets of ANNs, wherein each additional set of ANNs only includes one or more ANNs from a previous set of ANNs that are ranked above a predetermined threshold level.

### BACKGROUND

The present invention relates generally to the field of machine learning, and more particularly to evolutionary algorithm analytics.

An evolutionary algorithm (EA) is a subset of evolutionary computation, a generic population-based metaheuristic optimization algorithm. An EA uses mechanisms inspired by biological evolution, such as reproduction, mutation, recombination, and selection. Candidate solutions to the optimization problem play the role of individuals in a population, and the fitness function determines the quality of the solutions. Evolution of the population then takes place after the repeated application of the above operators.

Artificial neural networks (ANN) are computing systems inspired by biological neural networks. The ANN itself is not an algorithm, but a framework for many different machine learning algorithms to work together and process complex data inputs. Such systems learn to perform tasks by considering examples, without being programmed with any task-specific rules. Instead, ANNs automatically generate identifying characteristics from the learning material. ANNs are based on a collection of connected units or nodes called artificial neurons, which loosely model the neurons in a biological brain. Each connection, like the synapses in a biological brain, can transmit a signal from one artificial neuron to another. An artificial neuron that receives a signal can process the signal and then transfer the signal to additional artificial neurons.

In common ANN implementations, the signal at a connection between artificial neurons is a real number, and the output of each artificial neuron is computed by some non-linear function of the sum of its inputs. The connections between artificial neurons are called edges. Artificial neurons and edges typically have a weight that adjusts as learning proceeds. The weight increases or decreases the strength of the signal at a connection. Artificial neurons may have a threshold such that the signal is only sent if the aggregate signal crosses that threshold. Typically, artificial neurons are aggregated into layers. Different layers may perform various kinds of transformations on their inputs. Signals travel from the first layer (i.e., input layer) to the last layer (i.e., output layer), after traversing the layers multiple times.

### SUMMARY

Embodiments of the present invention disclose a computer-implemented method, a computer program product, and a system. The computer-implemented method includes one or more computer processers selecting a set of artificial neural networks (ANN(s)). The one or more computer processors determine a selection criteria from a set of input data, wherein the selection criteria is utilized as a reward function. The one or more computer processors rank each ANN in the set of ANNs based on respective fitness values calculated from respective returned output data responsive to the set of input data, wherein each ANN in the set of ANNs is ranked in a context of maximizing the determined selection criteria. The one or more computer processors iteratively create additional sets of ANNs, wherein each additional set of ANNs only includes one or more ANNs from a previous set of ANNs that are ranked above a predetermined threshold level.

### BRIEF DESCRIPTION OF THE DRAWINGS

Figure (i.e., FIG. 1 is a functional block diagram illustrating a computational environment, in accordance with an embodiment of the present invention;

FIG. 2 is a flowchart depicting operational steps of a program, on a server computer within the computational environment of FIG. 1, for simulated network evolution leveraging modified selection mechanisms and mutations, in accordance with an embodiment of the present invention; and

FIG. 3 is a block diagram of components of the server computer, in accordance with an embodiment of the present invention.

### DETAILED DESCRIPTION

Machine learning and Artificial Neural Networks (ANNs) have many powerful use cases that include visual image recognition, modeling predictions based on historical data, and uncovering hidden insights within large data structures. However, training said ANNs while selecting weights, biases, and activations for comprised nodes add unnecessary bias to ANNs that gradually degrade the model allowing low fidelity predictions. Additionally, low quality ANNs are further exacerbated when insufficient training data is utilized to train the ANNs. Increased speed and reliability in developing accurate ANNs have demonstrated a clear advantage in many industrial sectors but significant issues arise when training data is not available in a sufficient quantity (e.g., training data quantity that results in a high-fidelity ANN). These issues thereby can cause significant delays in the creation, training, and testing of ANNs and subsequently delay the deployment and application of ANNs.

Embodiments of the present invention improve ANN creation and training by leveraging modified selection mechanisms and mutations to simulate ANN evolution, allowing advanced network and data analysis. Embodiments of the present invention are not limited to artificially selecting neural architectures or being limited to supervised machine learning that requires large training datasets. Embodiments of the present invention improve ANNs by removing unnecessary biases while maintaining a comparable fidelity and uncovering novel correlations, mechanisms, and insights within a large dataset. Embodiments of the present invention further improve ANN creation and training through synthetic data generation while maintaining statistical assumptions from a small training dataset through evolutionary behavior and data simulation. Embodiments of the present invention analyze subsequent emergent networks and relationships between comprised fitness criteria, features, and variables. Implementation of embodiments of the invention may take a variety of forms, and exemplary implementation details are discussed subsequently with reference to the Figures.

The present invention will now be described in detail with reference to the Figures.

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

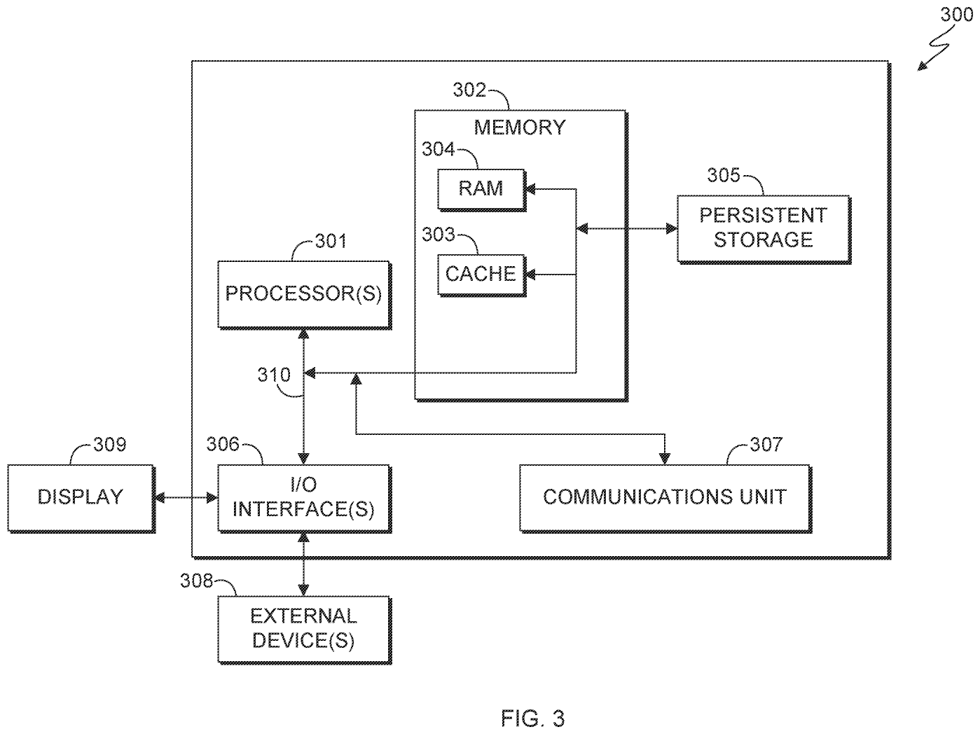

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes database 122 and program 150. In other embodiments, server computer 120 may contain other applications, databases, programs, etc. which have not been depicted in computational environment 100. Server computer 120 may include internal and external hardware components, as depicted and described in further detail with respect to FIG. 3.

Database 122 is a repository for data used by program 150. In the depicted embodiment, database 122 resides on server computer 120. In another embodiment, database 122 may reside elsewhere within computational environment 100 provided program 150 has access to database 122. A database is an organized collection of data. Database 122 can be implemented with any type of storage device capable of storing data and configuration files that can be accessed and utilized by program 150, such as a database server, a hard disk drive, or a flash memory. In an embodiment, database 122 stores data used by program 150, such as historical mutations, historical selection criteria, historical fitness values, and emergent feature correlations, and historical emergent favored parameters. In an embodiment, database 122 contains training data 124.

Training data 124 contains one or more examples, sets of training data, data structures, and/or variables used to fit the parameters of a specified network or model. The contained data comprises of pairs of input vectors with associated output vectors. In an embodiment, training data 124 may contain one or more sets of one or more instances of unclassified or classified (e.g., labelled) data, hereinafter referred to as training statements. In another embodiment, the training data contains an array of training statements organized in labelled training sets. For example, a plurality of training sets includes “positive” and “negative” labels paired with associated training statements (e.g., words, sentences, etc.). In an embodiment, each training set includes a label and an associated array or set of training statements which can be utilized to train one or more networks or models. In an embodiment, training corpus data contains unprocessed training data. In an alternative embodiment, training corpus data contains natural language processed (NLP) (e.g., section filtering, sentence splitting, sentence tokenizer, part of speech (POS) tagging, tf-idf, etc.) feature sets. In a further embodiment, training data 124 contains vectorized (i.e., one-hot encoding, word embedded, dimension reduced, etc.) training sets, associated training statements, and labels.

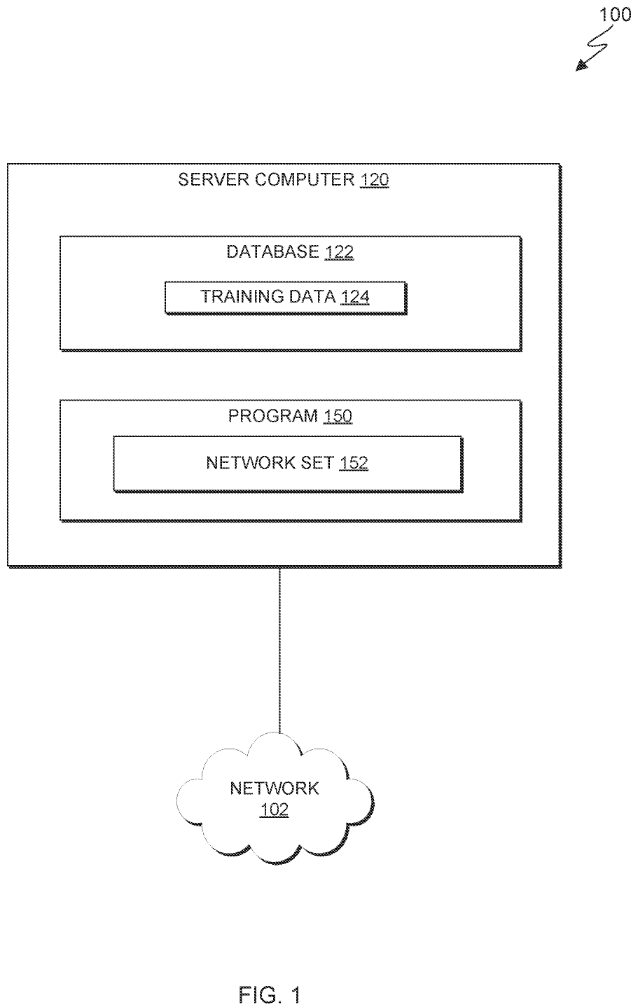

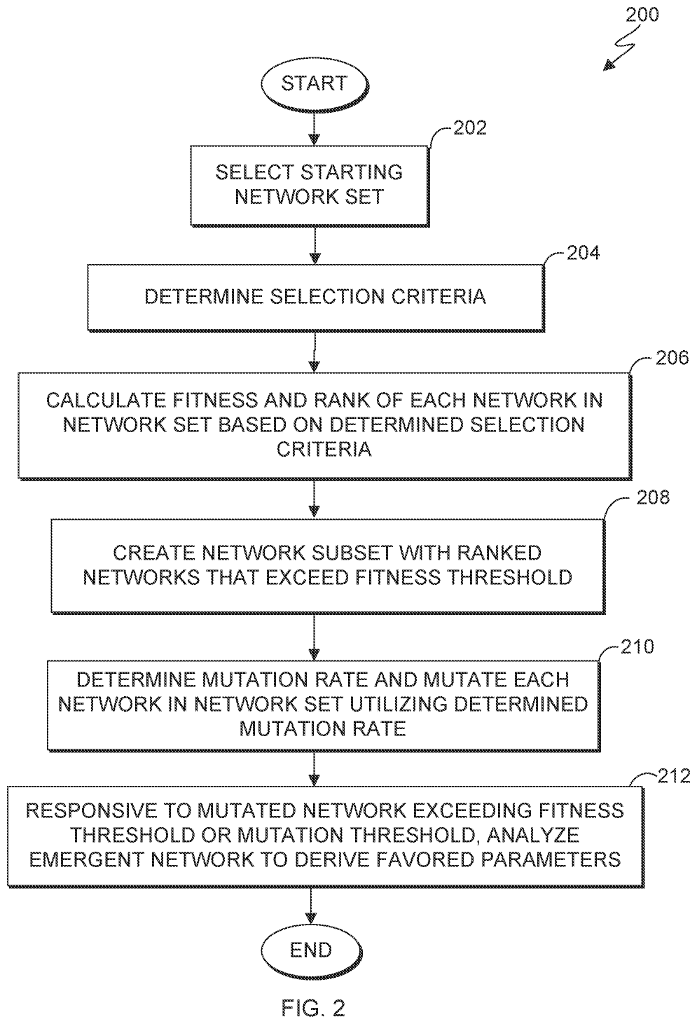

Program 150 is a program for simulated network evolution leveraging modified selection mechanisms and mutations. In various embodiments, program 150 may implement the following steps: select a set of artificial neural networks (ANN(s)); determine a selection criteria from a set of input data, wherein the selection criteria is utilized as a reward function; each ANN in the set of ANNs based on respective fitness values calculated from respective returned output data responsive to the set of input data, wherein each ANN in the set of ANNs is ranked in a context of maximizing the determined selection criteria; and iteratively create additional sets of ANNs, wherein each additional set of ANNs only includes one or more ANNs from a previous set of ANNs that are ranked above a predetermined threshold level. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. In the depicted embodiment, program 150 includes network set 152. Program 150 is depicted and described in further detail with respect to FIG. 2.

Network set 152 is representative of a set (i.e., population) or one or more subsets of machine learning models or networks (i.e., individuals) that utilize deep learning techniques to train, calculate weights, ingest inputs, and output a plurality of solution vectors. In an embodiment, the models or networks contained within network set 152 are comprised of any combination of deep learning model, technique, and algorithm, where the models or networks are associated with distinct sets of parameters, hyperparameters, features, or attributes (i.e., genomes). In an embodiment, the networks comprised within network set 152 utilize transferrable neural networks algorithms and models (e.g., long short-term memory (LSTM), deep stacking network (DSN), deep belief network (DBN), convolutional neural networks (CNN), compound hierarchical deep models, etc.) that are trained with evolutionary training algorithms and methods. The training of the comprised models and networks is depicted and described in further detail with respect to FIG. 2.

The present invention may contain various accessible data sources, such as database 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 depicts flowchart 200 illustrating operational steps of program 150 for simulated network evolution leveraging modified selection mechanisms and mutations, in accordance with an embodiment of the present invention.

Program 150 selects a starting network set (step 202). In an embodiment, program 150 initiates responsive to a user inputting training data 124 or the user inputting network set 152 (i.e., population) containing one or more previously trained networks and models (i.e., individuals). In responsive to a user inputted training data 124, program 150 partitions training data 124 into a plurality of training, testing, and validation sets. In an embodiment, each set is classified, paired, associated, and/or linked with one or more labels or output vectors. In another embodiment, program 150 partitions training data 124 into discrete sets containing multiple versions of the same set and label, for example, sets processed utilizing different natural language processing techniques. In various embodiments, program 150 non-deterministically divides the processed sets into training, validation, and testing sets. Program 150 creates and trains each model within network set 152 utilizing the partitioned training, validation, and testing sets. Responsively, program 150 selects a set of the trained models as the starting network set 152 (i.e., initial population). In another embodiment, program 150 selects the user inputted models as network set 152 (i.e., population, first set, initial set, etc.). In an embodiment, each model in network set 152 is distinct, where each model contains a unique set of attributes, parameters (e.g., variables), and/or hyperparameters (e.g., learning rates, hidden layers, etc.).

Program 150 determines selection criteria (step 204). Program 150 determines a selection criteria or mechanism to be utilized as a reward function for each model within network set 152 utilizing training data 124 or a received set of input data. In an embodiment, program 150 utilizes the reward function to yield a favorable outcome, for example, a favorable model output such as profitability, desired change in key industry metrics, etc. In an embodiment, program 150 utilizes the selection criteria to determine top models in network set 152. In this embodiment, highly ranked models will “survive and reproduce” with a greater frequency than those models with deficient performance, allowing a larger concentration of highly ranked models in a subsequent network subset (i.e., child models or networks) with parameters and hyperparameters (i.e., genomes) similar to the top models in a prior network subset (i.e., parent models or networks). In an embodiment, program 150 utilizes feature selection methods, such as univariate selection, feature importance, and correlation matrixes to determine the selection criteria.

Program 150 calculates a fitness and rank of each network in network set based on the determined selection criteria (step 206). Program 150 calculates a fitness value for each network in network set 152 utilizing the determined selection criteria as a basis for the fitness value. In an embodiment, each network in network set 152 is inputted with identical input data and each network returns a set of output data that is analyzed within the context of the determined selection criteria. In an embodiment, program 150 calculates a plurality of fitness values that represent the quality and predictive accuracy of each network in network set 152. In this embodiment, fitness values include, but are not limited to, Brier scores, Gini coefficients, discordant ratios, C-statistic values, net reclassification improvement indexes, receiver operating characteristics, generalized discrimination measures, Hosmer-Lemeshow goodness of fit values, error rates (e.g., root mean squared error, mean absolute error, mean absolute percentage error, mean percentage error, etc.), precision, overfitting considerations, and related environment, system, server statistics (e.g., memory utilization, processor utilization, storage utilization, etc.). In this embodiment, program 150 runs one or more evaluation, validation, and testing methods on each network in network set 152 utilizing testing environments. In various embodiments, program 150 utilizes the fitness values to calculate a fitness delta value between each network in network set 152. For example, program 150 calculates an accuracy difference between two models and utilizes the difference as the fitness delta value.

In an embodiment, program 150 utilizes the respective calculated fitness values to arrange, rank, and/or order each network in network set 152. Program 150 may rank each network in network set 152 based on a plurality of factors, specified by the user, or the model, based on statistics, metrics, and values such as predictive accuracy, error rates, training duration, etc. For example, program 150 ranks each network in the network set based on a predictive accuracy metric. In this example, higher rank models have a higher predictive accuracy than lower ranked models. In another embodiment, the calculated fitness score serves as a priority score allowing program 150 to determine the most effective model (i.e., most fit model) based on plurality of fitness values. In an embodiment, program 150 assigns a model with a label (e.g., primary, secondary, auxiliary, etc.) corresponding to the relative ranking of said model. For example, program 150 assigns the highest ranked model with the label of primary. In this embodiment, higher ranked models are deemed more suitable or appropriate (e.g., conform to the largest number of requirements or standards) than lower ranked models.

Program 150 creates a network subset with ranked networks that exceed a fitness threshold (step 208). In an embodiment, program 150, iteratively, removes all ranked networks within network set 152 that do not exceed a fitness threshold. In various embodiments, program 150 utilizes a predetermined rank or fitness threshold, based on user, application, or network preferences, eliminating any networks having a fitness or rank less than or below said threshold. In this embodiment, the fitness threshold is predetermined by the user or program dynamically adjusts the fitness threshold. For example, program 150 adjusts the fitness threshold to only include networks or models that exceed a 95% predicative accuracy. In an embodiment, the user specifies the threshold type and/or value. In other embodiments, the model, system, or production server requirements dictate the threshold value. For example, an exemplary production server may only have sufficient computational storage for a small network set 152 (e.g., >500 megabytes). In this example, program 150 adjusts the threshold to track model storage requirements and adjusts the value to conform with the requirements of the production server.

Program 150 determines a mutation rate and mutates each network in the network set according to the determined mutation rate (step 210). In an embodiment, program 150 creates a new network subset (i.e., additional set of networks) containing a set of models created from non-deterministically crossing over the “genomes” of each model within the created network subset. In this embodiment, program 150 crosses genomes associated one or more pairs of models in the created network subset, described in step 208, by selecting a random point in a vector representing the genomes of a model within a model pair, where the crossover or exchange occurs. This crossover creates a new set of distinct models that each contain attributes (i.e., genomes) associated with a respective parent model. For example, program 150 utilizes one-point crossover methods to select one crossover point where attributes are exchanged between a pair of models, creating two child models. In another example, program 150 utilizes two-point crossover to select two crossover points where attributes are exchanged, creating two child models but said child models are more distinct than with one-point crossover.

Responsive to crossover, program 150 determines a mutation rate, where program 150 randomly replaces and changes attributes associated with a model or network set to create new child models while avoiding local optima. For example, in binary attributes, one or more randomly chosen attributes are switched from 0 to 1 or from 1 to 0. Here, program 150 utilizes mutation to produce new models that are substantially different from parent models, while increasing model diversity in the network subset. In an embodiment, program 150 adjusts the mutation rate based on the number of models in network set 152 or in any subsequent network subset. For example, if the size of network set or subset is too small (i.e., lack of search space) then the model solution can get stuck in a local optimum. In another example, if the size of network set 152 is exceptionally large, then the increased area of search is increased exponentially increases computational load. In another embodiment, program 150 adjusts the mutation rate based on the number of allowed or requested generations (i.e., network subsets). In an embodiment, program 150 utilizes NeuroEvolution of Augmenting Topologies (NEAT) to mutate existing connections or add new structures to a network or model. For example, program 150 mutates a model by adding a new connection between a start and end node and assigns a random weight. In another example, program 150 mutates a model by adding a node between two existing nodes, which disables the previous connection while maintaining the presence of the genome. In this example, the previous start node is linked to the new node with the weight of the old connection and the new node is linked to the previous end node with a random weight.

Program 150, responsive to a mutated network exceeding a fitness or mutation threshold, analyze mutated network to derive emergent network favored parameters (step 212). In an embodiment, program 150 analyzes and derives emergent network parameters associated with one or more mutated models or networks that exceed a fitness (e.g., fitness variances) or mutation threshold (e.g., fixed number of generations). Program 150 determines a relationship between the inputs, the hidden layers, the weights, and activation functions of the resulting mutated networks and how the relationship influences emergent outputs. For example, program 150 compares the mutated network following the final evolutionary cycle to an initial population or parent networks to derive favored parameters contributing to the increased evolutionary fitness. Here, program 150 identifies how the highest ranked ANN incorporates the set of input data to reach maximum fitness relative to a selected set of ANNs. In an embodiment, program 150 utilizes the derived parameters to generate synthetic data that cause subsequently trained models to retain attributes similar to the one or more mutated models or networks that exceed the fitness or mutation threshold (i.e., highly fit individuals). In another embodiment, program 150 utilizes the generated synthetic data in a machine learning pipeline to initiate model development regardless of the size of training data 124. Program 150 creates, initiates, trains, and deploys one or more mutated models utilizing training data 124 and generated synthetic data. In an embodiment, program 150 manages (i.e., facilitating correct storage, querying, and fetching of the training data) a development pipeline of one or more machine learning models based on a level of correctness associated with the generated synthetic data points allowing program 150 to implement an initial model architecture that allows the real-time ingesting of synthetic data and new real data. Embodiments of the present invention recognize that the synthetic data can be now used in a standard machine learning pipeline to initiate the model development regardless the existing constraints in data availability.

FIG. 3 depicts block diagram 300 illustrating components of server computer 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 120 each include communications fabric 310, which provides communications between cache 303, memory 302, persistent storage 305, communications unit 307, and input/output (I/O) interface(s) 306. Communications fabric 310 can be implemented with any architecture designed for passing data and/or control information between processors (such as microprocessors, communications, and network processors, etc.), system memory, peripheral devices, and any other hardware components within a system. For example, communications fabric 310 can be implemented with one or more buses or a crossbar switch.

Memory 302 and persistent storage 305 are computer readable storage media. In this embodiment, memory 302 includes random access memory (RAM) 304. In general, memory 302 can include any suitable volatile or non-volatile computer readable storage media. Cache 303 is a fast memory that enhances the performance of computer processor(s) 301 by holding recently accessed data, and data near accessed data, from memory 302.

Program 150 may be stored in persistent storage 305 and in memory 302 for execution by one or more of the respective computer processor(s) 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data can be stored in persistent storage 305 for access and/or execution by one or more of the respective processors 301 via cache 303.

Communications unit 307, in these examples, provides for communications with other data processing systems or devices. In these examples, communications unit 307 includes one or more network interface cards. Communications unit 307 may provide communications through the use of either or both physical and wireless communications links. Program 150 may be downloaded to persistent storage 305 through communications unit 307.

I/O interface(s) 306 allows for input and output of data with other devices that may be connected to server computer 120. For example, I/O interface(s) 306 may provide a connection to external device(s) 308, such as a keyboard, a keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 305 via I/O interface(s) 306. I/O interface(s) 306 also connect to a display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
selecting, by one or more computer processors, a set of artificial neural networks (ANN(s));
determining, by one or more computer processors, a selection criteria from a set of input data, wherein the selection criteria is utilized as a reward function;
ranking, by one or more computer processors, each ANN in the set of ANNs based on respective fitness values calculated from respective returned output data responsive to the set of input data, wherein each ANN in the set of ANNs is ranked in a context of maximizing the determined selection criteria; and
iteratively creating, by one or more computer processors, additional sets of ANNs, wherein each additional set of ANNs only includes one or more ANNs from a previous set of ANNs that are ranked above a predetermined threshold level.

2. The computer-implemented method of claim 1, wherein iteratively creating the one or more additional sets of ANNs, comprises:
determining, by one or more computer processors, a mutation rate for the ANNs in the set of ANNs, wherein the mutation rate is utilized to randomly replace and remove genomes associated with each ANN in the set of ANNs; and
creating, by one or more computer processors, the additional sets of ANNs by mutating the previous set of ANNs utilizing the determined mutation rate.

3. The computer-implemented method of claim 2, further comprising:
responsive to exceeding a threshold level of fitness or a number of iterations, analyzing, by one or more computer processors, a highest ranked ANN within the additional sets of ANNs to derive relationships among parameters and how the highest ranked ANN incorporates the set of input data to reach maximum fitness relative to the selected set of ANNs.

4. The computer-implemented method of claim 3, further comprising:
determining, by one or more computer processors, relationships between hidden layers, associated weights and activation functions of each ANN in the one or more additional sets of ANNs relative to the set of input data.

5. The computer-implemented method of claim 1, further comprising:
generating, by one or more computer processors, synthetic input data to allow subsequently trained ANNs to retain genomes similar to the previous set of ANNs.

6. The computer-implemented method of claim 2, further comprising:
selecting, by one or more computer processors, a random point in a vector representing a genome associated each ANN in a pair of ANNs, wherein the random point controls an exchange of portions of the genome between each ANN in the pair of ANNs resulting in an additional set of ANNs.

7. The computer-implemented method of claim 2, further comprising:
mutating, by one or more computer processors, each ANN in the previous set of ANNs by randomly adding a new node between a start node and an end node with a randomly assigned weight.

8. A computer program product comprising:
one or more computer readable storage media and program instructions stored on the one or more computer readable storage media, the stored program instructions comprising:
program instructions to select a set of artificial neural networks (ANN(s));
program instructions to determine a selection criteria from a set of input data, wherein the selection criteria is utilized as a reward function;
program instructions to rank each ANN in the set of ANNs based on respective fitness values calculated from respective returned output data responsive to the set of input data, wherein each ANN in the set of ANNs is ranked in a context of maximizing the determined selection criteria; and
program instructions to iteratively create additional sets of ANNs, wherein each additional set of ANNs only includes one or more ANNs from a previous set of ANNs that are ranked above a predetermined threshold level.

9. The computer program product of claim 8, wherein the program instructions to iteratively create the one or more additional sets of ANNs, comprise:
program instructions to determine a mutation rate for the ANNs in the set of ANNs, wherein the mutation rate is utilized to randomly replace and remove genomes associated with each ANN in the set of ANNs; and
program instructions to create the additional sets of ANNs by mutating the previous set of ANNs utilizing the determined mutation rate.

10. The computer program product of claim 9, wherein the program instructions, stored on the one or more computer readable storage media, further comprise:
program instructions to, responsive to exceeding a threshold level of fitness or a number of iterations, analyze a highest ranked ANN within the additional sets of ANNs to derive relationships among parameters and how the highest ranked ANN incorporates the set of input data to reach maximum fitness relative to the selected set of ANNs.

11. The computer program product of claim 10, wherein the program instructions, stored on the one or more computer readable storage media, further comprise:
program instructions to determine relationships between hidden layers, associated weights and activation functions of each ANN in the one or more additional sets of ANNs relative to the set of input data.

12. The computer program product of claim 8, wherein the program instructions, stored on the one or more computer readable storage media, further comprise:
program instructions to generate synthetic input data to allow subsequently trained ANNs to retain genomes similar to the previous set of ANNs.

13. The computer program product of claim 9, wherein the program instructions, stored on the one or more computer readable storage media, further comprise:
program instructions to select a random point in a vector representing a genome associated each ANN in a pair of ANNs, wherein the random point controls an exchange of portions of the genome between each ANN in the pair of ANNs resulting in an additional set of ANNs.

14. The computer program product of claim 9, wherein the program instructions, stored on the one or more computer readable storage media, further comprise:
program instructions to mutate each ANN in the previous set of ANNs by randomly adding a new node between a start node and an end node with a randomly assigned weight.

15. A computer system comprising:
one or more computer processors;
one or more computer readable storage media; and
program instructions stored on the computer readable storage media for execution by at least one of the one or more processors, the stored program instructions comprising:
program instructions to select a set of artificial neural networks (ANN(s));
program instructions to determine a selection criteria from a set of input data, wherein the selection criteria is utilized as a reward function;
program instructions to rank each ANN in the set of ANNs based on respective fitness values calculated from respective returned output data responsive to the set of input data, wherein each ANN in the set of ANNs is ranked in a context of maximizing the determined selection criteria; and
program instructions to iteratively create additional sets of ANNs, wherein each additional set of ANNs only includes one or more ANNs from a previous set of ANNs that are ranked above a predetermined threshold level.

16. The computer system of claim 15, wherein the program instructions to iteratively create the one or more additional sets of ANNs, comprise:
program instructions to determine a mutation rate for the ANNs in the set of ANNs, wherein the mutation rate is utilized to randomly replace and remove genomes associated with each ANN in the set of ANNs; and
program instructions to create the additional sets of ANNs by mutating the previous set of ANNs utilizing the determined mutation rate.

17. The computer system of claim 16, wherein the program instructions, stored on the one or more computer readable storage media, further comprise:
program instructions to, responsive to exceeding a threshold level of fitness or a number of iterations, analyze a highest ranked ANN within the additional sets of ANNs to derive relationships among parameters and how the highest ranked ANN incorporates the set of input data to reach maximum fitness relative to the selected set of ANNs.

18. The computer system of claim 17, wherein the program instructions, stored on the one or more computer readable storage media, further comprise:
program instructions to determine relationships between hidden layers, associated weights and activation functions of each ANN in the one or more additional sets of ANNs relative to the set of input data.

19. The computer system of claim 15, wherein the program instructions, stored on the one or more computer readable storage media, further comprise:
program instructions to generate synthetic input data to allow subsequently trained ANNs to retain genomes similar to the previous set of ANNs.

20. The computer system of claim 16, wherein the program instructions, stored on the one or more computer readable storage media, further comprise:
program instructions to select a random point in a vector representing a genome associated each ANN in a pair of ANNs, wherein the random point controls an exchange of portions of the genome between each ANN in the pair of ANNs resulting in an additional set of ANNs.
